(19) United States
(12) Patent Application Publication
(10) Pub. No.: US 2026/0312077 A1
(43) Pub. Date: Oct. 8, 2026

(54) OXYGEN REDUCTION CATALYST AND USE THEREOF

(71) Applicant: TOYOTA JIDOSHA KABUSHIKI KAISHA, Toyota-shi (JP)

(72) Inventor: Keiichi OKUBO, Toyota-shi (JP)

(73) Assignee: TOYOTA JIDOSHA KABUSHIKI KAISHA, Toyota-shi (JP)

(21) Appl. No.: 19/437,665

(22) Filed: Dec. 31, 2025

(30) Foreign Application Priority Data
Apr. 4, 2025 (JP) 2025-062735

(51) Int. Cl. H01M 4/86; C25B 1/04; C25B 11/065; C25B 11/081; H01M 4/92; H01M 8/10; H01M 8/1004; H01M 8/1039

(52) U.S. Cl. CPC H01M 4/8657; C25B 1/04; C25B 11/065; C25B 11/081; H01M 4/926; H01M 8/1004; H01M 8/1039; H01M 2008/1095

(57) ABSTRACT

An oxygen reduction catalyst may include a catalyst metal having oxygen reduction reaction activity: and a modified layer including a copolymer or a cation thereof. The copolymer may include a structural unit derived from melamine, a structural unit derived from formaldehyde, and a structural unit derived from an amino group-containing compound having one or two amino groups.

### CROSS REFERENCE TO RELATED APPLICATION

This application claims priority to Japanese Patent Application No. 2025-062735 filed on Apr. 4, 2025. The entire content of the priority application is incorporated herein by reference.

### TECHNICAL FIELD

The art disclosed herein relates to an oxygen reduction catalyst and use thereof.

### BACKGROUND ART

Organic nitrogen compounds that are added to catalyst metals used in fuel cells and water electrolysis systems are known to enhance the activity of oxygen reduction reactions in the catalysts, thereby improving the power generation efficiency of the fuel cells. Examples of such organic nitrogen compounds include, for example, melamine-formaldehyde polymers obtained by polymerizing monomers containing aldehyde groups (JP 2024-11754A).

### SUMMARY

However, since melamine has three amino groups as polymerization sites, the melamine-formaldehyde polymers are three-dimensionally crosslinked. Therefore, the melamine-formaldehyde polymers tend to accumulate as thick layers on catalyst metal surfaces, which may impede a supply of reactants to catalyst metals.

The disclosure herein provides a technique for adjusting three-dimensional crosslinking of a melamine-formaldehyde polymer added to an oxygen reduction reaction catalyst to contribute to maintaining the oxygen reduction activity of a catalyst metal.

The disclosure herein relates to an oxygen reduction catalyst. The oxygen reduction catalyst may comprise a catalyst metal having oxygen reduction reaction activity: and a modified layer comprising a copolymer or a cation thereof. The copolymer may comprise a structural unit derived from melamine, a structural unit derived from formaldehyde, and a structural unit derived from an amino group-containing compound having one or two amino groups.

According to this oxygen reduction catalyst, the modification layer contains the above-described copolymer. Since the amino group-containing compound has one or two amino groups, a three-dimensional crosslink is not formed upon reaction with formaldehyde. Accordingly, in the copolymer, three-dimensional crosslinking between melamine and formaldehyde is suppressed. Thus, deposition of the modified layer is suppressed and inhibition of supply of reactants to the catalyst metal is suppressed or avoided.

### DETAILED DESCRIPTION

The oxygen reduction catalyst disclosed herein may further include the aspects below. In another aspect of the oxygen reduction catalyst, the amino group-containing compound may comprise urea and/or benzoguanamine. This efficiently suppresses three-dimensional crosslinking of the copolymer.

In another aspect of the oxygen reduction catalyst, in the copolymer, a substance ratio (mol) of the amino group-containing compound relative to the melamine is 1.0 or less. This appropriately suppresses, for example, three-dimensional crosslinking of the copolymer so that the oxygen reduction activity of the catalyst metal can be sufficiently exhibited.

The disclosure herein is also directed to a cathode for a fuel cell comprising the above-described oxygen reduction catalyst and to a fuel cell comprising this cathode.

The disclosure herein is also directed to an anode for a water electrolysis system comprising the above-described oxygen reduction catalyst and to a water electrolysis system comprising this anode.

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved oxygen reduction catalysts and uses thereof.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Hereinafter, various embodiments of the oxygen reduction catalyst disclosed herein (which may be simply referred to as “the catalyst” hereinafter) are described in detail.

The oxygen reduction catalyst disclosed herein may be used for fuel cells such as PEFCs, or may be used for water electrolysis systems. The catalyst disclosed herein may be used for a cathode of a fuel cell, used for an anode of a fuel cell, used for an anode of a water electrolysis system, or used for a cathode of a water electrolysis system.

The oxygen reduction catalyst disclosed herein may be in the form of, for example, a catalyst ink, or may be in a layered form as a so-called electrode. A binder described below can be used as needed.

### (Oxygen Reduction Catalyst)

The oxygen reduction catalyst disclosed herein comprises a catalyst metal and a modified layer comprising a copolymer or a cation thereof, wherein the copolymer comprises a structural unit derived from melamine, a structural unit derived from formaldehyde, and a structural unit derived from an amino group-containing compound having one or two amino groups. Hereinafter, these elements are described in detail. The cation of the copolymer includes cases in which basic functional groups in the copolymer are dissociated and ionized and form a salt with an organic or inorganic acid.

### (Catalyst Metal)

The catalyst metal contained in the catalyst is not particularly limited so long as it has oxygen reduction activity. For example, examples of the catalyst metal include metals such as platinum, ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium. One or more of these metals can be used in combination. The catalyst metal may be an oxide, nitride, sulfide, or phosphide, and one or more of these oxides may be used in combination.

Among the above, the catalyst metal may be preferably one or more selected from platinum, platinum alloys, and complexes containing platinum. Examples of the metals other than platinum contained in the platinum alloys or the platinum-containing complexes include ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium, and the metals may comprise two or more of these metals. The atomic percentages of the metals other than platinum in the platinum alloys are not particularly limited and may be 0.11 to 50 at %.

The catalyst metal is typically in the form of particles. The average particle diameter is not specifically limited and may be, for example, 1 nm or more and 100 nm or less.

The catalyst metal may be supported on a carrier. The carrier may be one or more selected from carbon and oxides. Examples of carbon include conductive carbons, carbon black (acetylene black, Ketjen black, channel black, roller black, disk black, oil furnace black, gas furnace black, lamp black, thermal black, and VULCAN (registered trademark) carbon, etc.), activated carbon, black lead, glassy carbon, graphite, graphene, carbon fibers, carbon nanotubes, carbon nitrides, carbon sulfides, and carbon phosphides, and two or more of these can be used in combination. Examples of the oxides include titanate oxides, niobate oxides, tin oxides, tungstate oxides, and molybdate oxides, and one or more of these oxides can be used.

The carrier may be primary particles or secondary particles. The average particle diameter of the primary particles is not particularly limited and may be, for example, 5 nm or more and 500 nm or less.

### (Modified Layer)

The modified layer is provided on the surface of the catalyst metal to accelerate the oxygen reduction activity of the catalyst metal. The modified layer contains a copolymer comprising a structural unit derived from melamine, a structural unit derived from formaldehyde, and a structural unit derived from an amino group-containing compound having one or two amino groups (hereinafter simply referred to as “copolymer”) or a cation thereof. This includes cases where a salt is formed between a cation and a cation resulting from ionization of the basic functional group of the copolymer or between a cation and an organic or inorganic acid.

### (Copolymer)

The copolymer contained in the modified layer is not particularly limited as long as it promotes oxygen reduction activity by the catalyst metal. One or more copolymers can be used in combination. The copolymer comprises at least a structural unit derived from melamine represented by the formula (I) below.

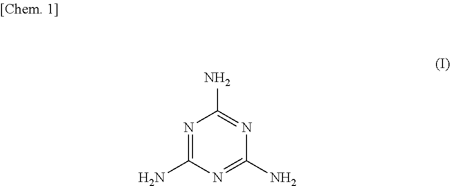

The copolymer may instead comprise a structural unit derived from a melamine derivative represented by the formula (II) below.

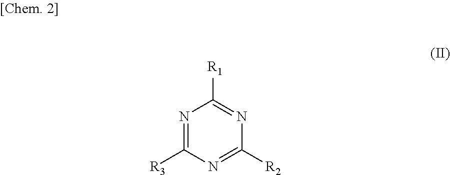

In the formula (II), each of R₁, R₂, and R₃ is a hydrogen atom, a halogen atom, or a functional group selected from the group consisting of: nitrile groups, amide groups, imine groups, amino groups, thiol groups, hydroxyl groups, sulfo groups, carboxylic acid groups, phosphate groups, ketone groups, aldehyde groups, ester groups, alkoxy groups, phenolic groups, cyclopentyl groups, cyclohexyl groups, alkylamino groups having 1 to 10 carbon atoms, alkylsulfonic acid groups having 1 to 10 carbon atoms, perfluoroalkyl groups having 1 to 10 carbon atoms, alkyl groups having 1 to 10 carbon atoms, alkenylamino groups having 1 to 10 carbon atoms, alkenylsulfonic acid groups having 1 to 10 carbon atoms, perfluoroalkenyl groups having 1 to 10 carbon atoms, and alkenyl groups having 1 to 10 carbon atoms. The functional group may, on the molecular chain, have at least one member selected from the group consisting of: at least one functional group selected from the above-listed functional groups, an aromatic ring, a heterocycle, an oxygen atom, a sulfur atom, a nitrogen atom, a fluorine atom, a chlorine atom, a bromine atom, an iodine atom, and a hydrogen atom. In the formula (II), each of R₁, R₂, and R₃ may be a primary amine, a secondary amine, a tertiary amine, or a quaternary ammonium cation. However, in the formula (II), R₁, R₂, and R₃ are not all amino groups or cations thereof.

When one or two of R₁, R₂, and R₃ are amino groups in the compound represented by the formula (II), this compound corresponds to the amino group-containing compound disclosed herein.

Although the copolymer comprises a structural unit derived from melamine and a structural unit derived from formaldehyde, in some cases, it may comprise a structural unit derived from a melamine derivative and/or a structural unit derived from an amino group-containing compound having one or two amino groups.

The amino group-containing compound is not particularly limited as long as it has one or two amino groups. An amino group-containing compound having one amino group may be preferable in effectively suppressing three-dimensional crosslinking. An amino group-containing compound having one amino group may also be preferable in forming a linear segment while suppressing three-dimensional crosslinking.

Examples of amino group-containing compound having one amino group include compounds represented by the formula (II) in which one of R₁, R₂, and R₃ is an amino group. Examples of amino group-containing compound having two amino groups include urea and compounds represented by the formula (II) in which two of R₁, R₂, and R₃ are amino groups. Such compounds are not particularly limited, but one example benzoguanamine.

The ratio between the structural unit derived from melamine, the structural unit derived from formaldehyde, and the structural unit derived from the amino group-containing compound having one or two amino groups in the copolymer is not particularly limited. From the viewpoint of suppressing three-dimensional crosslinking and accelerating oxygen reduction reaction activity by the catalyst metal, it may be preferable that a substance ratio (molar ratio) of the structural unit derived from the amino group-containing compound relative to the structural unit derived from melamine is 1.0 or less. When the ratio exceeds 1.0, suppression of three-dimensional crosslinking may lead to reduced promoting effect of the copolymer, as a nitrogen-containing organic compound, on oxygen reduction reaction activity of the catalyst metal. The above substance ratio means that the substance ratio of the amino group-containing compound used as a monomer relative to melamine used as a monomer in synthesis of the copolymer is 1.0 or less.

The copolymer may further comprise structural unit(s) derived from additional monomers, in addition to the above-described structural units. For example, the copolymer may comprise a structural unit derived from thiocyanuric acid. Examples of thiocyanuric acid compounds include thiocyanuric acid and derivatives thereof. Examples of cyanuric acid compounds include cyanuric acid and derivatives thereof.

Such copolymers are obtained by reacting melamine, formaldehyde, and the amino group-containing compound under polymerizable conditions. For example, a condition in accordance with the polymerization condition for melamine and formaldehyde may be adopted. The degree of polymerization, molecular weight of the copolymer are not particularly limited. The presence of the copolymer in the modified layer provides strong adsorption to the catalyst metal and improves adsorption stability. The copolymer may have a degree of polymerization in the range of 1 to 10,000.

Examples of such copolymers include copolymers containing melamine, formaldehyde, and urea as monomers (addition products) and copolymers containing melamine, formaldehyde, and benzoguanamine as monomers (condensation products).

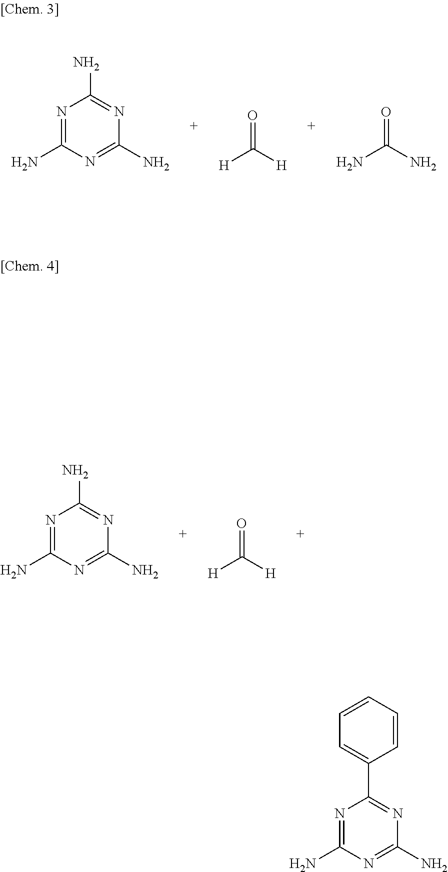

Such resins can be synthesized by those skilled in the art or are commercially available. For example, such resins are available as the U-VAN (registered trademark) series from Mitsui Chemicals and the EPOSTER (registered trademark) series from Nippon Shokubai Co., Ltd.

The content of the copolymer in the catalyst is not particularly limited. For example, the content of the copolymer (or the total mass including other copolymers) relative to the mass of the catalyst metal carrier may be 1.0 mass % or more and 15 mass % or less.

Here, the mass of the copolymer is measured by extracting the copolymer from the catalyst and using chromatography such as HPLC or GC. The mass of the carrier can be measured in the following method. First, organic compounds such as the copolymer and binder are removed from the catalyst by solvent separation, and the carrier supporting the remaining catalyst metal is obtained. Then, the catalyst metal carrier is calcined to remove the carrier and the mass of the carrier is measured from the residue. For identification of the copolymer and carrier, an appropriate method such as mass spectra, NMR, IR, or UV can be used.

### (Binder)

The catalyst can further include a binder. The binder is a polymer electrolyte containing an ion exchange group such as an acidic functional group or a basic functional group. The polymer electrolyte may be referred to as an electrolyte or ionomer. Examples of the acidic functional group include sulfonic acids and phosphoric acids. Examples of the basic functional group include quaternary ammonium cations. The binder may be a perfluorocarbon sulfonic acid polymer, an anion exchange polymer, or a polymer primarily composed of polyether ether ketone or polybenzimidazole.

The content of the binder in the catalyst is not particularly limited as long as it can form the modified layer on the catalyst metal. For example, the ratio of the binder's mass to the carrier's mass can be 70 mass % or more and 115 mass % or less. The mass of the carrier has already been described. The mass of the binder is measured by extracting the binder from the catalyst. For identification of the binder, an appropriate method such as mass spectrometry, NMR, IR, or UV can be used.

As described above, the catalyst can be in the form of a catalyst ink, and after application of the catalyst ink, it can be in the form of a catalyst layer. Hereinafter, formation of a catalyst ink and a catalyst layer is described.

### (Preparation of Catalyst Ink)

First, predetermined amounts of a catalyst metal carrier (carrier supporting a catalyst metal), organic nitrogen compound(s), a radical quencher, a binder, and a solvent are added to a container, and they are stirred by a stirrer to prepare a catalyst ink. The type of solvent is not particularly limited and any liquid can be used. Examples of the solvent include alcohols and mixtures of at least one alcohol and water. Examples of the alcohols include methanol, diacetone alcohol, ethanol, 1-propanol, 2-propanol, tert-butyl alcohol, ethylene glycol, and propylene glycol.

The stirrer is not particularly limited and any known stirrer can be used. Examples of the stirrer include ultrasonic homogenizers, jet mills, ball mills such as bead mills, high-shear mixers, and philmix. Stirring conditions such as stirring speed, stirring time, and rotation speed are not particularly limited and may be set as appropriate.

After stirring, vacuum degassing is performed, and the container is left to stand for one day. The standing time is not particularly limited and may be set as desired. Alternatively, the container may not be left to stand. Furthermore, the vacuum degassing may be performed again.

### (Formation of Catalyst Layer)

The prepared catalyst ink is applied onto a predetermined substrate, and the solvent is removed after the application. For example, the catalyst ink is applied onto the substrate, and the applied catalyst ink is heated to dry and remove the solvent.

The substrate is not particularly limited and examples of the substrate include polytetrafluoroethylene (PTFE), electrolyte membranes having ion exchange groups, gas diffusion layers (GDLs) composed of carbon fibers and/or metal fibers, and gas diffusion layers composed of carbon fibers and/or metal fibers having microporous layers (MPLs).

The method of applying the catalyst ink onto the substrate may be any method as long as it can uniformly apply the catalyst ink onto the substrate, and the method may be die coating, spin coating, screen printing, doctor blade coating, squeegee coating, spray coating, or applicator coating. The heating rate and heating time may be appropriately set depending on the type of solvent. Additionally, the removal rate may be increased by degassing simultaneously with heating. The layer thickness may be 5 to 30 μm, and the catalyst ink may be applied such that the platinum content satisfies 0.1 to 0.6 mg·cm⁻².

### (Catalyst Layer)

According to the disclosure herein, an oxygen reduction catalyst layer or an oxygen generation catalyst layer containing the above-described catalyst is provided. Since the oxygen reduction reaction of the catalyst metal is reversible, a fuel cell comprising this catalyst layer as a cathode (oxygen reduction catalyst layer) is also provided. The fuel cell may be, for example, a PEFC. In such a fuel cell, a decrease in the power generation efficiency of the fuel cell due to radical generation is avoided or suppressed.

Furthermore, a water electrolysis device comprising a catalyst layer containing the above-described catalyst as an anode (oxygen evolution reaction catalyst layer) is also provided. In such a water electrolysis device, a decrease in the water generation efficiency of the water electrolysis device due to radical generation is avoided or suppressed.

### EXAMPLES

Hereinafter, examples of the disclosure herein are described. These examples are provided to illustrate the disclosure herein and are not intended to limit the scope of the disclosure.

### Example 1

Predetermined amounts of a catalyst-metal-particle carrier in which platinum particles (particle diameter: 3 to 4 nm) as a catalyst metal are supported on a carrier (acetylene black), a copolymer having a composition shown in the table below, a perfluorocarbon sulfonic acid as a binder, and a water-alcohol mixture as a solvent were put into a container. The mass of the copolymer relative to the mass of the carrier was 0.03.

These materials were mixed and stirred by a stirrer (homogenizer, philmix) to prepare catalyst inks of Examples 1 to 4 containing the oxygen reduction catalyst.

A catalyst ink of Comparative Example 1 was prepared in the same manner as Example 1 except for the omission of the copolymer. Further a catalyst ink of Comparative Example 2 was prepared in the same manner as Example 1 except that the copolymer contains melamine. Furthermore, a catalyst ink of Comparative Example 3 was prepared in the same manner as Example 1 except for use of a melamine-formaldehyde polymer (melamine resin) instead of the copolymer.

After degassed appropriately, each catalyst ink was applied onto a substrate and the catalyst ions were heated after the application to remove the solvent, thereby forming a catalyst layer.

Then, the formed catalyst layers were used as cathode catalyst layers, perfluorocarbon sulfonic acid polymer (Chemours Nafion NR211, EW: 1100) was used as electrolyte membranes, and platinum-supported carbon catalyst (Tanaka Precious Metal Technologies Co., Ltd., TEC10E50E) was used as anode catalyst layers. Each electrolyte membrane was sandwiched between a cathode catalyst layer and an anode catalyst layer. Under the heat (130° C.) and pressure (3 MPa), the cathode catalyst layer, the electrolyte membrane, and the anode catalyst layer were thermally bonded. Gas diffusion layers (SGL Corporation, 22BB) made of carbon fibers were placed on the outer sides of the cathode catalyst layer and the anode catalyst layer to make a membrane electrode assembly (MEA) (electrode portion: 1 cm×1 cm).

TABLE 1

| | | | | | | Cell voltage |
|---|---|---|---|---|---|---|
| | | Type of copolymer, etc. | | | | difference, |
| | | | | | Molar ratio of | Compared to |
| | | | Mass ratio of | | amino-containing | Comparative |
| | | | copolymer to | Amino-containing | compounds to | Example at |
| Sample Type | | Copolymer | carrier | compound | melamine | 3.2 A/cm² |
| Examples | 1 | Melamine- | 0.03 | Urea | 1.0 or less | 65 |
| | | Formaldehyde- | | | | |
| | | Urea | | | | |
| | 2 | Same as above | 0.03 | Same as above | more than 1.0 | 40 |
| | 3 | Melamine- | 0.03 | Benzoguanamine | 1.0 or less | 49 |
| | | Formaldehyde- | | | | |
| | | Benzoguanamine | | | | |
| | 4 | Same as above | 0.03 | Same as above | more than 1.0 | 40 |
| Comparative | 1 | None | 0 | None | — | 0 |
| Example | 2 | Melamine | 0.03 | None | — | 31 |
| | 3 | Melamine- | 0.3 | None | — | 31 |
| | | Formaldehyde | | | | |

Then, the MEAs were used as single cells to measure current-voltage characteristics under low humidity condition (30% RH) and high humidity condition (80% RH). The measurement conditions were as follows: sweep rate: 20 mA/s (anode sweep), cell temperature: 80° C., pressure: 150 kPa_ABS, cathode gas: air, cathode gas flow rate: 2.0 L/min. For each of the MEAs, a cell voltage at 3.2 A/cm² was measured. The cell voltage at 3.2 A/cm² is in a region where concentration overpotential, which indicates transport characteristics of reactants, is dominant, and thus is a region where supply of reactants to the catalyst surface is important. A higher cell voltage in this region indicates superior reactant transport characteristics and better cell performance. Table 1 shows the differences in cell voltage at 3.2 A/cm² relative to Comparative Example 1.

As shown in Table 1, Example 1, which uses the copolymer containing urea as an amino group-containing compound at a substance ratio of 1.0 or less relative to melamine, exhibited the highest cell voltage. Example 3, which uses the copolymer containing benzoguanamine as an amino group-containing compound at a substance ratio of 1.0 or less relative to melamine, showed the next highest cell voltage.

In contrast, in Example 4 where the amount of benzoguanamine is more than 1.0 in Comparative Examples 2 and 3 where the amount of urea is more than 1.0 in Example 1, the cell voltages were decreased. Examples 1 to 4 exhibited higher cell voltages compared to Comparative Examples 2 and 3 in which melamine and melamine resin were used as organic nitrogen compounds, respectively.

From the above, it has been found that use of melamine-formaldehyde-based copolymers that comprise structural units derived from monomers of amino group-containing compounds such as urea and benzoguanamine is effective for improving cell performance. In other words, it has been found that such copolymers facilitate supply of reactants to the catalyst metal and improves catalyst activity as a nitrogen-containing organic compound. Furthermore, it has been found that by setting the substance ratio of these amino group-containing compounds to melamine in the copolymer at 1.0 or less, the supply of reactants and catalyst activity can be further effectively improved.

What is claimed is:

1. An oxygen reduction catalyst comprising:
a catalyst metal having oxygen reduction reaction activity: and
a modified layer comprising a copolymer or a cation thereof,
wherein the copolymer comprises a structural unit derived from melamine, a structural unit derived from formaldehyde, and a structural unit derived from an amino group-containing compound having one or two amino groups.

2. The oxygen reduction catalyst according to claim 1, wherein the amino group-containing compound comprises urea.

3. The oxygen reduction catalyst according to claim 1, wherein the amino group-containing compound comprises benzoguanamine.

4. The oxygen reduction catalyst according to claim 1, wherein in the copolymer, a substance ratio of the amino group-containing compound relative to the melamine is 1.0 or less.

5. A cathode for a fuel cell comprising the oxygen reduction catalyst according to claim 1.

6. A fuel cell comprising the cathode according to claim 5.

7. An anode for a water electrolysis system comprising the oxygen reduction catalyst according to claim 1.

8. A water electrolysis system comprising the anode according to claim 7.
